(19) United States
(12) Patent Application Publication
(10) Pub. No.: US 2026/0265924 A1
(43) Pub. Date: Sep. 10, 2026

(54) ELECTROLYSIS SYSTEM HAVING AN ION EXCHANGER

(71) Applicant: Siemens Energy Global GmbH & Co. KG, München (DE)

(72) Inventors: Bernd Merkl, Igensdorf (DE); Markus Ungerer, Baiersdorf (DE); Klaus Scheffer, Nürnberg (DE); Henning Schramm, Daaden (DE)

(21) Appl. No.: 18/875,772

(22) PCT Filed: Jun. 7, 2023
(86) PCT No.: PCT/EP2023/065222

§ 371 Date: Dec. 17, 2024

(30) Foreign Application Priority Data
Jun. 17, 2022 (DE) 10 2022 206 095.4

(51) Int. Cl. C25B 1/04; C25B 9/21; C25B 15/08

(52) U.S. Cl. CPC C25B 1/04; C25B 9/21; C25B 15/083; C25B 15/087

(57) ABSTRACT

An electrolysis system contains: at least one electrolysis cell; a cathode-side water circuit having a hydrogen separator; an anode-side water circuit having an oxygen separator; an equalization connection which leads, coming from a cathode-side water connection, to the anode-side water circuit via a pump and an ion exchanger via a node point and an operating line; and an idle line which branches off upstream of the control line and leads to the cathode-side gas connection.

The invention relates to an electrolysis system for the electrochemical separation of water for the generation of hydrogen and oxygen with electrolysis cells, wherein an anode-side water circuit and a cathode-side water circuit for separating the gases are present. In doing so, the purity of the water is to be guaranteed by means of ion exchangers.

Electrolysis systems are known in different embodiments from the prior art. In any case, it comprises an electrolyzer. For this, on the other hand, different embodiments are employed, wherein often a so-called PEM electrolyzer is employed. It has a plurality of electrolysis cells which are divided into an anode chamber and a cathode chamber through a polymer electrolyte membrane. Water electrolysis takes place in the electrolysis cells, wherein an inlet is present at least on the anode chamber. An outlet via which the respective created gas with a percentage of water is discharged is located on the top side of the anode chamber and on the top side of the cathode chamber.

On the anode side, there is usually a water circuit from the outlet of the anode chamber with an oxygen separator back to the inlet on the anode chamber. Optionally, a circulation pump, a cooling device and a filter arrangement are further present in the water circuit. In order to guarantee sufficient purity of the water, an ion exchanger is employed in some embodiments at the anode-side water circuit.

The cathode side is generally set up analogously to the anode side and thus also has a water circuit from the outlet of the cathode chamber via a hydrogen separator back to the inlet of the cathode chamber.

In those systems where an ion exchanger is arranged directly in the respective water circuit, this leads to the requirement to design it for the full through-flow of the water circuit and is consequently generally larger than is required for cleaning the water.

Alternatively, embodiments are known where a cleaning circuit from the respective separator and back into the separator is present, wherein a pump and an ion exchanger are present in the cleaning circuit. Thus, it can be advantageously dimensioned.

However, it has further also been shown to be disadvantageous that in case of longer standstill times, the water quality in the electrolyzer decreases and, when it is started up again, efficiency is reduced and service life is impaired.

Furthermore, the water transition from the anode side to the cathode side through the PEM membrane, which is present during operation of the electrolyzer, has to be considered. Consequently, the transitioned water must be returned again. For this, connections from the cathode-side water circuit to the anode-side water circuit are provided in known systems, wherein generally, a pump and an ion exchanger are present in the connection.

It is an object of the present invention to provide a possibility of being able to guarantee the purity of the water also in case of non-operation of the electrolyzer and to keep the cleaning effort low at the same time.

This object is achieved with an electrolysis system according to the teachings of claim 1. Advantageous embodiments are the subject matter of the dependent claims.

The generic electrolysis system serves the electrochemical separation of water and thus the generation of hydrogen and oxygen. For this, the electrolysis system has at least one electrolysis cell. Generally, an electrolysis unit is used, which, again, possesses several electrolysis cells. The one or every single electrolysis cell possesses an anode chamber and a cathode chamber on an opposite side separated by a membrane. What type of membrane this is is initially irrelevant, wherein preferably a polymer electrolyte membrane is employed. There is an anode in the anode chamber and, on the opposite side, a cathode in the cathode chamber.

As intended, it is provided that during operation of the electrolysis system, a voltage is applied between the anode and the cathode of the one or the respective electrolysis cell so that the electrolysis process can take place and hydrogen and oxygen are formed.

By contrast, it is provided as intended that in an idle state of the electrolysis system, no voltage is present between the anode and the cathode and consequently no gas formation is present either.

During electrolysis, gases are created in the chambers so that a flow from bottom to top is formed. In doing so, the separated discharge of the created gases is to be guaranteed. Correspondingly, it is obvious that the cathode chamber and the anode chamber are generally flowed through from bottom to top during operation of the electrolysis system.

A water supply to the electrolysis cell is required for performing the method. For this, the electrolysis system has an anode-side water circuit. It can be separated into an anode-side water connection and an anode-side gas connection. The anode-side gas connection leads from an outlet of the anode chamber and to an oxygen separator. During operation of the electrolysis cell, the gas connection guides a mixture of gas and water from the anode chamber to the oxygen separator as intended. From there, a water connection leads back to an anode-side inlet on the anode chamber. Correspondingly, during operation, the anode-side water connection from the oxygen separator to the anode chamber is flowed through by water as intended.

Analogously, the electrolysis system has a cathode-side water circuit. It starts at a cathode-side outlet of the cathode chamber and leads to a hydrogen separator by means of a gas connection. During operation of the electrolysis cell, this gas connection also guides a mixture of gas and water from the cathode chamber to the hydrogen separator. From there, a water connection also leads back to a cathode-side inlet on the cathode chamber. Correspondingly, during operation, the cathode-side water connection from the hydrogen separator to the cathode chamber is flowed through by water.

Both in the anode-side water circuit and in the cathode-side water circuit, a main pump and/or a cooling means and/or a filter can furthermore be provided. The order of the elements is also initially irrelevant and also if further means are present in the water circuit.

In order to enable the return of the water which transitioned from the anode chamber to the cathode chamber during operation, an equalization connection is provided which leads from the cathode-side water connection to the anode-side water circuit. In order to ensure the purity of the returned water, a pump and an ion exchanger are provided in the equalization connection.

Advantageously, a cooling means and/or a filter can be provided in the equalization connection. The order of the elements is also initially irrelevant and also if further means are present in the equalization connection.

According to the invention, however, the equalization connection is not directly guided to the anode-side water circuit, but first to a node point. From there, an operating line leads to the anode-side water circuit and as a branch additionally an idle line to the cathode-side gas connection.

This embodiment enables on the one hand to deionize returned transfer water during return from the cathode side to the anode side in a known manner. However, the possibility of still operating a cleaning circuit during a standstill of the electrolysis, created by the particular embodiment, is particularly advantageous.

Generally, the equalization connection is provided to enable a return of water transitioned in the electrolysis cell via the operating line. In doing so, cleaning by means of an ion exchanger is required in order to avoid a disadvantageous ion burden on the anode side.

During operation of the electrolysis system, the equalization connection and subsequently the operating line are preferably flowed through so that there is a flow from the cathode-side water connection to the anode-side water circuit at least for equalization of the water transitioned in the electrolysis cell.

The equalization connection can be connected at different locations in the cathode-side water connection. Also, the operating line can be connected at different locations in the anode-side water circuit.

If several electrolysis cells are present, it can advantageously be provided that a water channel connecting the individual cathode chambers or the individual anode chambers is arranged on the lower side of the cathode chambers and/or on the lower side of the anode chamber, from which an inflow into the cathode chambers or anode chamber is possible.

If a water channel is present at the lower side of the cathode chamber and/or the anode chamber, the tubing of the associated cathode-side water connection or anode-side water connection, coming from the hydrogen separator or from the oxygen separator, is preferably connected to the cathode-side water channel or the anode-side water channel, i.e. the water channel forms a part of the water connection.

If several electrolysis cells are present, it can also advantageously be provided that a gas channel connecting the individual cathode chambers or individual anode chambers is arranged on the top side of the cathode chambers and/or on the top side of the anode chamber, from which it is possible to discharge the gas water mixture formed during operation from the cathode chambers or anode chambers.

If a gas channel is present, a tubing of the associated gas connection to the hydrogen separator or to the oxygen separator is connected to the associated gas channel, i.e. the gas channel is part of the gas connection.

Flexibility concerning the method management both during operation, i.e. when a voltage is applied between the anode and the cathode and electrolysis takes place, and in the idle state, when no voltage is applied on the electrolysis cell, is improved if a transverse flow connection from the cathode chamber to the anode chamber is present. It is provided that a flow from the cathode chamber to the anode chamber or from the anode chamber to the cathode chamber is possible through the transverse flow connection depending on the operating state.

Advantageously, this is a free passage from the lower side of the anode chamber, i.e. in the region of the inlet to the anode chamber, to the lower side of the cathode chamber, i.e. also in the region of the inlet to the cathode chamber.

If an anode-side water channel and/or cathode-side water channel is present, the transverse flow connection advantageously connects the water channels on the anode side and the cathode side to one another.

Although it is provided during operation that the water transitioned due to the process is returned via the equalization connection and subsequently the operating line, it can be provided on the one hand that additionally a part of the water is returned via the transverse flow connection. On the other hand, it can also be provided that more water is returned via the equalization connection than transitions at the chambers in the process. In this case, a transverse flow from the anode side through the transverse flow connection to the cathode side is possible.

Furthermore, it can be provided that a controllable valve or a check valve is arranged in the transverse flow connection.

The connection of the equalization connection to the cathode-side water connection can be at different locations. Obviously, the connection can be as a branch at a tubing connecting the hydrogen separator to the cathode chamber.

Also, the hydrogen separator alternatively comprises a connection, wherein it is to be ensured that only water and no gas is discharged via the equalization connection. Obviously, for example, two adjacent water connections can be present on the hydrogen separator, wherein the line to the cathode chamber is connected at one connection and the equalization connection is connected at the other connection.

Furthermore, alternatively, a connection on the lower side of the cathode chamber, for example adjacent to the connection of the tubing from the hydrogen separator, is possible. This enables a discharge of the transfer water directly before its entry into the cathode chamber. The same applies here as before, i.e. when water is discharged at the cathode chamber, substantially only water and no gas is discharged. For this, it is to be ensured that the flow from the tubing coming from the hydrogen separator is branched off proportionally directly into the equalization line without flowing through into the cathode chamber.

If a cathode-side water channel is present and it is provided that the equalization connection is to be connected to the lower side of the cathode chamber, the connection of the equalization connection is advantageously to the cathode-side water channel below the cathode chamber.

If a transverse connection is present, the equalization connection can be connected to the transverse connection in a particularly advantageous manner. Thus, a part of the transverse flow connection from the connection of the equalization connection to the cathode chamber at the same time forms the equalization connection. This enables a particularly simple and at the same time suitable tubing.

In all variants of the discharge of the transfer water from the lower side of the cathode chamber, it must be guaranteed that the transfer water is discharged immediately before it flows into the cathode chamber, so that a discharge of gas formed can substantially be excluded.

The connection of the operating line to the anode-side water circuit can also initially be first at any location.

In a preferred embodiment, the connection of the operating line is to the anode-side water connection. Thus, during operation of the electrolysis system, the anode-side water circuit is influenced least by the return of the transfer water and is thus easy to realize.

For the connection of the operating line to the anode-side water connection, analogously the same applies as for the connection of the equalization connection to the cathode-side water connection.

Correspondingly, it is possible to connect the operating line for the anode-side water connection to a tubing leading from the oxygen separator to the anode chamber.

In a particularly advantageous embodiment, the operating line is connected to the lower side of the anode chamber. Thus, the returned transfer water is supplied to the anode chamber over a short distance.

The connection of the operating line to the anode chamber can be done through a connection to the lower side of the anode chamber parallel to a tubing coming from the oxygen separator.

If an anode-side water channel is present on the lower side of the anode chamber, the operating line can further advantageously be connected to the anode-side water channel.

If a transverse connection is present, the operating line can advantageously be connected to the transverse connection. In doing so, a part of the transverse connection from the connection of the operating line to the anode chamber at the same time forms a section of the operating line. This enables a particularly simple and at the same time suitable tubing.

Particularly advantageous for all variants with the connection of the operating line to the lower side of the anode chamber is the return of the transfer water directly to the inlet in the anode chamber.

In an alternative embodiment, the connection of the operating line is to the anode-side gas connection. While this requires more effort when considering the transfer water introduced into the anode-side gas connection, this variant enables further options in particular with regard to the operation management in the idle state.

When connecting the operating line to the anode-side gas connection, it is to consider that during operation of the electrolysis system, the water supplied from the operating line is guided to the oxygen separator together with the gas water mixture from the anode-side gas connection.

It can also be provided that the connection of the operating line is to the top side of the oxygen separator.

In the event that the idle line is to be connected to the cathode-side gas connection on the top side of the cathode chamber-for example for reasons of simpler tubing, a connection to the cathode-side gas channel-if available-is preferably provided for this purpose.

In order to enable different flow states during operation of the electrolysis system and in the idle state, it is both advantageous and obvious to employ valves in the lines or connections or branches. It can be provided that a valve is present in the equalization line and/or a valve is present in the operating line and/or in the idle line. It would also be possible to provide a multi-way valve in the node point.

Furthermore, it is also possible to provide one or more valves, respectively, in the anode-side water connection and/or the cathode-side water connection and/or in the anode-side gas connection and/or in the cathode-side gas connection in order to be able to influence the flow both during operation and in the idle state.

Advantageously, during operation, the idle line is shut off by means of a valve, for example, so that no flow is present there.

However, it is also possible that also during operation of the electrolysis system, a proportional flow through the idle line is present as intended and thus a cleaning circuit from the hydrogen separator and back to the hydrogen separator is present.

In the idle state, on the other hand, when no voltage is applied to the electrolysis cell, the idle line is preferably flowed through, wherein it is preferably provided that a flow from the idle line to the cathode chamber and from there to the equalization connection via the cathode-side water connection is present.

Depending on whether only the water in the cathode chamber or also the water in the anode chamber is to be cleaned via the ion exchanger in the equalization connection in the idle state, the operating line is disrupted or also flowed through depending on the type of tubing.

The pump present in the equalization connection can cause a flow from the cathode-side water connection through the equalization connection and subsequently the idle line to the cathode-side gas connection. This means that the flow direction in the equalization connection from the cathode-side water connection to the node point is the same both during operation and in the idle state of the electrolysis system.

During operation of the electrolysis system, the flow in the chambers of the electrolysis cell is unavoidably from bottom to top due to the gas formation. By contrast, no direction is predetermined for the idle state of the electrolysis cell. Thus, it would be possible that the chambers are also flowed through from bottom to top for cleaning. However, for the idle state, a flow through the cathode chamber and/or the anode chamber from top to bottom against the flow direction given during operation is particularly preferred.

With the preferred opposite flow through the cathode chamber, when connecting the idle line to the cathode-side gas connection, care must be taken that a flow from the idle line to the top side of the cathode chamber is possible in the idle state. Preferably, a connection into a tubing of the gas connection connecting the cathode chamber to the hydrogen separator or a connection at a cathode-side gas channel is provided.

If there is a flow through the cathode chambers from top to bottom in the idle state, the water must obviously be returned from the lower side of the cathode chambers to the equalization connection.

Different variants are available for this. In a first embodiment, a backflow is via the cathode-side water connection at least in sections.

It is preferably provided that the water, which flows through the cathode chamber from top to bottom in the opposite direction, is also returned to the equalization connection via the cathode-side water connection opposite to the flow direction present during operation. If the equalization connection is connected to the tubing between the hydrogen separator and the cathode chamber, it is obvious that the section is flowed through backwards from the cathode chamber to the equalization connection in the idle state. If, however, the equalization connection is connected to the hydrogen separator, it is obvious in this embodiment that the water flows back to the hydrogen separator and from there into the equalization connection in the idle state.

If, however, the equalization connection is directly connected to the lower side of the cathode chamber, the tubing of the cathode-side water connection, i.e. from the hydrogen separator to the lower side of the cathode chamber, is not flowed through in the idle state. As previously explained, the equalization connection can be connected to a cathode-side water channel or to a transverse connection.

Furthermore, it is advantageously possible that both chambers are flowed through via the equalization connection in the idle state. This means that there is a flow from the equalization connection to the cathode chamber via the node point and the idle line and further a flow from the equalization connection to the anode chamber via another line.

Different possibilities are available for this. In a first variant, the operating line is employed to guide a water flow to the anode chamber in the idle state as well. This means that in the operating state, substantially only the operating line is flowed through and in the idle state, there is a division of the water deionized in the equalization connection to the operating line and the idle line. For this, it is particularly advantageous that the operating line is connected to the anode-side gas connection.

In a second variant, a further second idle line to the anode-side gas connection is employed parallel to the idle line to the cathode-side gas connection. Usefully, the operating line runs to the anode-side water connection. Here, it can be provided that the second idle line branches off from the first idle line or is connected to the equalization connection via a further node point. At least during operation of the electrolysis system there is a flow via the operating line substantially to the anode-side water connection and in the idle state via the idle line to the anode-side gas connection and via the second idle line to the cathode-side gas connection.

If the water from the anode chamber is cleaned via the equalization connection, obviously a return of the water from the anode chamber to the cathode side is required.

For this, if the transverse flow connection is present, the water in the idle state can advantageously be led via the transverse flow connection from the anode chamber to the cathode chamber or from an advantageously present anode-side water channel via the transverse flow connection to an advantageously present cathode-side water channel.

However, a second embodiment where the equalization connection is directly connected to the transverse flow connection is particularly advantageous. Thus, in the idle state, the water can flow from both the anode chamber and the cathode chamber via the transverse flow connection from both sides to the equalization connection.

If cleaning the water at the anode side during operation is requested as well, a cleaning loop can be provided which leads from and to the anode-side water circuit. For this, a pump and an ion exchanger are also required in the cleaning loop. Furthermore, a cooling means and a filter can additionally be provided.

It is particularly advantageous if the cleaning loop leads from the anode-side water connection, for example from the oxygen separator, to the anode-side gas connection. This particularly enables a water guidance from the oxygen separator via the cleaning loop back to the oxygen separator during operation, and in the idle state, a water guidance from the anode-side water connection, for example from the oxygen separator, via the cleaning loop to the anode-side gas connection and through the anode chamber back into the anode-side water connection.

The electrolysis system according to the invention enables a new method according to the invention for controlling such an electrolysis system. The substantial and the advantageous method steps result in an obvious manner from the previous description of the electrolysis system according to the invention and its advantageous design.

In general, a distinction is to be made between the operating state of the electrolysis system and its idle state. During operation, a voltage is applied between the anode and the cathode, which results in the electrolysis and thus the formation of hydrogen and oxygen. This creates a circuit flow in the anode-side water circuit and a circuit flow in the cathode-side water circuit. A gas water mixture flows from the respective chamber to the associated separator through the associated gas connection. There, the respective gas is separated, wherein the water is returned to the associated chamber via the associated water connection.

At the same time, water transitions from the anode chamber into the cathode chamber during operation. Therefore, for equalization, it is provided that water from the anode-side water connection is returned to the anode-side water circuit via the equalization connection and then the operating line. The flow is effected through the pump in the equalization connection, wherein furthermore an ion exchanger for cleaning the water is present.

By contrast, in the idle state, the connection from the anode to the cathode is without voltage and thus it is obvious that there is no electrolysis with the gas formation. By contrast, the pump in the equalization connection is still operated, wherein, however, only the water is led to the cathode chamber through the idle line.

In the idle state, the water from the cathode-side water connection is particularly advantageously guided via the equalization connection on the one hand via the idle line to the cathode chamber and on the other hand via the operating line or a second idle line to the anode chamber.

In the following figures, exemplary embodiments of an electrolysis system are outlined. In the drawings:

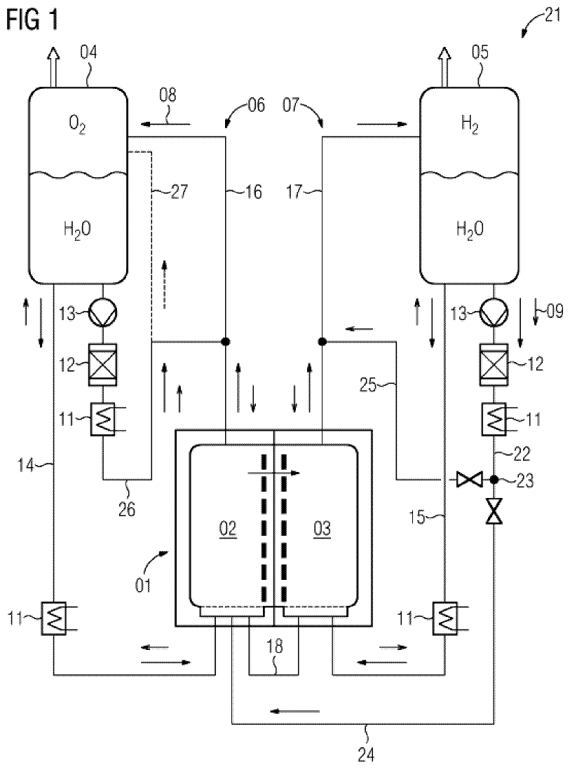

FIG. 1 shows a first exemplary embodiment of an electrolysis system with an equalization connection connected to the hydrogen separator, an operating line to the anode chamber;

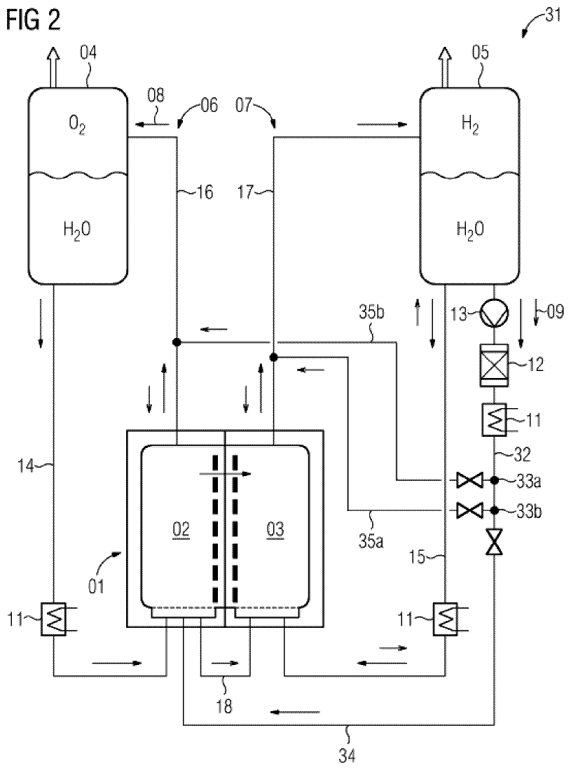

FIG. 2 shows a second exemplary embodiment of an electrolysis system, wherein, additionally to the embodiment of FIG. 1, a second idle line leads to the anode-side gas connection;

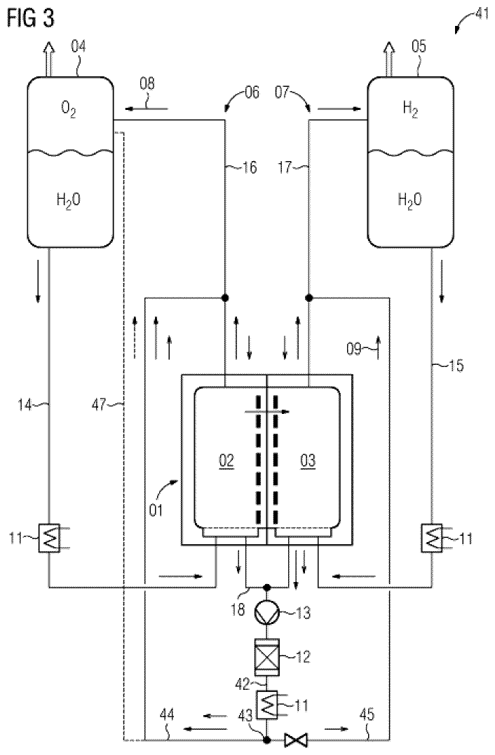

FIG. 3 shows a third exemplary embodiment of an electrolysis system with an equalization connection connected to a transverse flow connection;

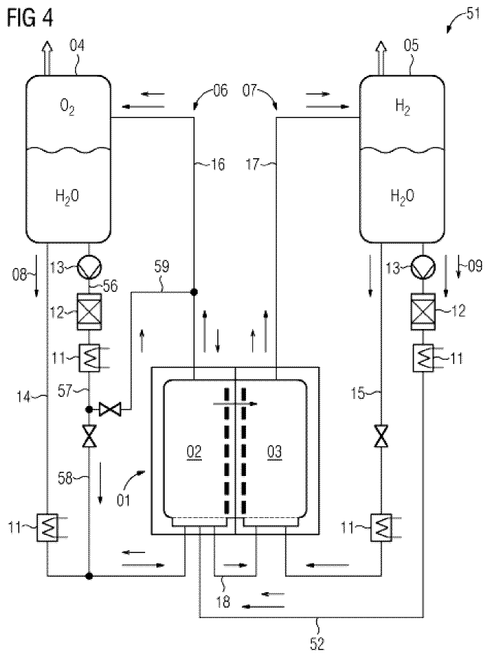

FIG. 4 shows a fourth exemplary embodiment of an optional cleaning loop on the anode side.

FIG. 1 outlines a first exemplary embodiment of an electrolysis system 21 according to the invention. It 21 initially has the electrolysis cell 01 with the anode chamber 02 and cathode chamber 03 located therein. The two chambers 02, 03 are separated by a PEM membrane. There is a respective water channel at the lower side of the respective chamber 02, 03 in order to be able to guarantee the simple introduction of the water into the respective chamber 02, 03. Furthermore, the electrolysis system 21 comprises an oxygen separator 04 and a hydrogen separator 05.

The cathode-side water circuit 07 is on the right side of FIG. 1. It 07 comprises a cathode-side water connection 15 from the hydrogen separator 05 to the cathode chamber 03 and a cathode-side gas connection 17 from the cathode chamber 03 to the hydrogen separator 05. During operation of the electrolysis system 21, water flows from the hydrogen separator 05 to the lower side of the cathode chamber 03 through the cathode-side water connection 15 and a gas water mixture flows from the top side of the cathode chamber 03 to the hydrogen separator 05 through the cathode-side gas connection 17.

The anode-side water circuit 06 is on the left side of FIG. 1. It 06 comprises an anode-side water connection 14 from the oxygen separator 04 to the anode chamber 02 and an anode-side gas connection 16 from the anode chamber 02 to the oxygen separator 04. During operation of the electrolysis system 21, water flows from the oxygen separator 04 to the lower side of the anode chamber 02 and a gas water mixture flows from the top side of the anode chamber 02 to the oxygen separator 04 through the anode-side gas connection 16.

The flow direction during operation of the electrolysis system 21 is outlined with the long arrows 08.

A respective cooler 11 is provided in the water connections 14, 15.

Furthermore, this exemplary embodiment represents a transverse flow connection 18 which 18 connects the lower side of the anode chamber 02 to the lower side of the cathode chamber 03, i.e. in this case connects the respective water channels of the two chambers 02, 03 to one another.

Furthermore, this exemplary embodiment represents a cleaning loop 26 which 26 leads from the oxygen separator 04 to the anode-side gas connection 16. A pump 13, an ion exchanger 12 and a cooler 11 are arranged in the cleaning loop 26.

By means of the cleaning loop 26, a proportionate cleaning of the water circulating in the anode-side water circuit is possible during operation of the electrolysis system 21.

Alternatively, it would also be possible to return the cleaning loop 26 directly to the oxygen separator 04—see alternative line 27.

Particularly advantageously, continued cleaning of the water in the anode chamber 02 is possible with the cleaning loop 26 in the idle state of the electrolysis system 21. The water flows from the cleaning loop 26 in the opposite direction through the anode chamber 02 and through the anode-side water connection 14 also in the opposite direction back to the oxygen separator 04.

On the cathode side, an equalization connection 22 is connected on the hydrogen separator 05, which 22 leads to the lower side of the anode chamber 02 via a node point 23 and an operating line 24, i.e. to the anode-side water channel. A pump 13, an ion exchanger 12 and a cooler 11 are arranged in the equalization connection 22. Thus, during operation of the electrolysis system 21, the water that transitioned in the electrolysis cell 01 can be cleaned and returned to the anode side via the equalization connection 22.

Furthermore, an idle line 25 is provided, which 25 leads from the node point 23 to the cathode-side gas connection 17. It is provided that the idle line 25 is interrupted during operation of the electrolysis system 21. By contrast, in the idle state of the electrolysis system 21, the operating line 24 is shut off and the flow from the equalization connection 22 leads to the cathode chamber 03 via the idle line 25. It 03 is flowed through backwards, wherein the water in the following is returned backwards to the oxygen separator 05 through the cathode-side water connection 15.

The provided flow direction for the idle state is outlined through the short arrows 09.

The following FIG. 2 outlines another exemplary embodiment of an electrolysis system 31 according to the invention. Again, the electrolysis cell 01 with the anode chamber 02 and the cathode chamber 03 as well as the oxygen separator 04 and the hydrogen separator 05 are present.

Also, there is an anode-side water circuit 06 with the anode-side water connection 14 and the anode-side gas connection 16. Also, the cathode-side water circuit 07 with the cathode-side water connection 15 and the cathode-side gas connection 17 is present in consistence with the previous example.

Equally, the equalization connection 32 with the operating line 34 connected thereto is present in consistence with the previous example.

In contrast to the previous example, however, it is now provided that, in addition to the pipeline 35a from the node point 33a to the cathode-side gas connection 17, there is also a second idle line 35b from a second node point 33b to the anode-side gas connection 16.

Initially, in accordance with the previous example, it is provided that the operating line 34 is enabled and the idle lines 35a, 35b are shut off during operation of the electrolysis system 31.

In contrast, in the idle state of the electrolysis system 31 with the operating line 34 shut off, there is a flow through both idle lines 35a and 35b parallel to the anode chamber 02 on the one hand and to the cathode chamber 03 on the other hand.

The water flowing backwards in the cathode chamber 03 is, as before, returned to the hydrogen separator 05 via the cathode-side water line 15.

In contrast, the water flowing backwards in the anode chamber 02 is initially guided to the lower side of the cathode chamber 03 via the transverse flow connection 18, so that the water can be led back from there via the cathode-side water connection 15.

FIG. 3 outlines another preferred exemplary embodiment of an electrolysis system 41 according to the invention. It has, again, the electrolysis cell 01 with the anode chamber 02 and the cathode chamber 03 in consistence with previous examples. Also, the oxygen separator 04 and the hydrogen separator 05 are present, which 04, 05 are respectively integrated into the corresponding anode- side water circuit 06 or cathode-side water circuit 07.

Here, however, it is provided in contrast to the previous exemplary embodiments that the equalization connection 42 is connected to the transverse flow connection 18. The equalization connection 42 also has a pump 13, the ion exchanger 12 and a cooler 11.

The operating line 44 now leads from the node point 43 following the equalization connection 42 to the anode-side gas connection 16. Analogously to the previous examples, the idle connection 45 connects the node point 43 to the cathode-side gas connection 17.

In the operating state of the electrolysis system 41, the water returned from the cathode-side flows from the lower side of the cathode chamber 03 through a partial piece of the transverse flow connection 18 to the anode-side gas connection 16 via the equalization connection 42 and the operating line 44.

In contrast, in the idle state of the electrolysis system 41, a flow is made possible from the equalization connection 42 on the one hand through the operating line 44 and through the idle connection 45 on the other hand, to the anode-side gas connection 16 on the one hand and to the cathode-side gas connection 17 on the other hand. This leads to a backwards flow through the anode chamber 02 and through the cathode chamber 03. At the lower side of the chambers 02, 03, the water is returned coming from both sides through the transverse flow connection 18 to the equalization connection 42.

Here, it can also be provided that, depending on the load, a proportion of the cleaned water coming from the equalization connection 42 is also further additionally supplied proportionally via the idle line to the cathode-side gas connection 17 at the same time during operation of the electrolysis system 41.

FIG. 4 outlines a further example of an electrolysis system 51. Here, in particular an alternative tubing for cleaning on the anode side is represented. The representation of the connection of an idle line from the equalization connection 52 to the cathode-side gas connection 17 according to the invention was dispensed with.

This exemplary embodiment initially outlines a cleaning loop corresponding with the first exemplary embodiment of FIG. 1. In this respect, the same method management as in the first example is possible.

However, it is provided that during operation of the electrolysis system 51 the flow is guided from a cleaning connection 56 connected to the oxygen separator 04 via a node point 57 and a cleaning operating line 58 to the anode-side water connection 14 near the inlet into the anode chamber 02. This avoids an impairment of the flow of the gas water mixture present in the gas connection 16.

In the idle state, however, the cleaning operating line 58 is shut off and the flow takes place, as in the first exemplary embodiment, from the cleaning connection 56 to the anode-side gas connection 16 via a cleaning idle line 59.

1-13. (canceled)

14. An electrolysis system for electrochemical generation of hydrogen and oxygen, the electrolysis system comprising:
a hydrogen separator;
an oxygen separator;
at least one electrolysis cell with an anode chamber having an anode and a cathode chamber having a cathode;
a cathode-side water circuit with a cathode-side water connection leading from said hydrogen separator to said cathode chamber and a cathode-side gas connection leading from said cathode chamber to said hydrogen separator;
an anode-side water circuit with an anode-side water connection leading from said oxygen separator to said anode chamber and an anode-side gas connection leading from said anode chamber to said oxygen separator;
an equalization connection having a pump and an ion exchanger and leads coming from said cathode-side water connection to a node point via said pump and said ion exchanger;
an operating line leading from said node point to said anode-side water circuit; and
an idle line leading from said node point to said cathode-side gas connection.

15. The electrolysis system according to claim 14, further comprising:
a respective cooler and/or a filter and/or a further pump disposed in one of said cathode-side water connection or said anode-side water connection or in both of said cathode-side water connections and said anode-side water connection; and/or
a respective cooler and/or a filter are disposed in said equalization connection and/or said operating line; and/or
a valve disposed in said operating line and/or said idle line and/or in said node point.

16. The electrolysis system according to claim 14, further comprising a transverse flow connection connecting a lower side of said anode chamber to a lower side of said cathode chamber.

17. The electrolysis system according to claim 14, further comprising a transverse flow connection, said equalization connection is connected in sections to said cathode-side water connection via said transverse flow connection connecting a lower side of said anode chamber to a lower side of said cathode chamber or connected to said lower side of said cathode chamber.

18. The electrolysis system according to claim 14, wherein:
said operating line leads to said anode-side water connection; or said operating line leads to said anode-side gas connection.

19. The electrolysis system according to claim 14, further comprising a transverse flow connection, said operating line in sections leads to said anode-side water connection via said transverse flow connection connecting a lower side of said anode chamber to a lower side of said cathode chamber or is connected to said lower side of said anode chamber.

20. The electrolysis system according to claim 14, wherein:
said idle line is interrupted during operation and is flowed through in an idle state; and
said operating line is flowed through during operation and is interrupted in the idle state.

21. The electrolysis system according to claim 14, wherein said cathode chamber is flowed through from top to bottom as intended coming from said equalization connection via said idle line in an idle state.

22. The electrolysis system according to claim 14, further comprising a second idle line, wherein said operating line or said second idle line leads to said anode-side gas connection, wherein, in an idle state, said cathode chamber is flowed through via said idle line and said anode chamber is flowed through via said operating line or said second idle line from top to bottom coming from said equalization connection.

23. The electrolysis system according to claim 20, wherein, in the idle state, in said cathode-side water connection a flow from said cathode chamber in a direction of said hydrogen separator is given at least in sections.

24. The electrolysis system according to claim 14, further comprising a cleaning loop which leads from said anode-side water connection to said anode-side gas connection and has a further pump and a further ion exchanger.

25. The electrolysis system according to claim 24, wherein:
during operation, a flow from said cleaning loop to said oxygen separator occurs and, in an idle state, a flow to the anode chamber is given; and/or in the idle state, a flow from the anode chamber in a direction of the oxygen separator is given in the anode-side water connection.

26. A method for controlling an electrolysis system, which comprises the steps of:
providing the electrolysis system according to claim 14;
applying a voltage between the anode and the cathode during operation of the electrolysis system, and a gas water mixture flows through a respective said gas connection from a respective said chamber to an associated said separator and water flows from the associated separator to the respective chamber through an associated said water connection;
branching off a flow from the cathode-side water connection by the pump which is effected by the equalization connection through the ion exchanger and through the operating line to the anode-side water circuit; and
in an idle state of the electrolysis system, no voltage is present between the anode and the cathode, and effecting a flow through the pump from the cathode-side water connection through the equalization connection through the ion exchanger and through the idle line to the cathode-side gas connection and further to the cathode chamber.
